(19) United States
(12) Patent Application Publication
(10) Pub. No.: US 2022/0202179 A1
(43) Pub. Date: Jun. 30, 2022

(54) FOLDABLE SUPPORT BASE

(71) Applicants: SOLUTION EXPERT 33 INTERNATIONAL CO., LTD. TAIWAN BRANCH (B.V.I.), New Taipei City (TW); SENSEAGE CO., LTD., Taipei City (TW); DONGGUAN SOLUTION 33 ELECTRONIC TECHNOLOGY CO., LTD., Dongguan City (CN); SOLUTION EXPERT 33 INTERNATIONAL CO., LTD., Tortola (VG)

(72) Inventor: Ben-Tien LIN, New Taipei City (TW)

(21) Appl. No.: 17/156,527

(22) Filed: Jan. 23, 2021

(30) Foreign Application Priority Data
Dec. 25, 2020 (CN) 202023173541.4

(51) Int. Cl. A47B 23/04; F16M 11/38

(52) U.S. Cl. CPC A47B 23/043; F16M 11/38

(57) ABSTRACT

The invention relates to a foldable support base which includes a baseplate and a folding layer. The baseplate has two first sides, two second sides and at least one anti-slip slot. The folding layer is connected to the baseplate and has a fist cutting line, two second cutting lines and a folding line set. The first cutting line is of a U-shape and disposed adjacent to each of the second sides and one of the first sides. The second cutting lines are located inside the first cutting line and extended parallelly with each other. A three-dimensional support structure is configured and folded by dividing the folding layer to multiple blocks through the first cutting line, the second cutting lines and the folding line set. Therefore, the support base may be folded into multiple modes and have anti-slip support effect.

### BACKGROUND OF THE INVENTION

### Technical Field

The invention relates to a support base, particularly to a foldable support base.

### Related Art

With the rapid development of technology in recent years, many people have a thin electronic device such as a smartphone, a touch tablet, or a personal digit assistant (PDA). When the users need to read the information displayed on the screen for a long time, they usually put these thin electronic devices on a table with a support frame to make the thin electronic devices be aslant supported on the table for viewing.

For storage and portability, some related-art support frames are designed to be an integrally formed foldable support frame. However, the thin electronic devices have certain weight and the table may have smooth surface, thereby the thin electronic devices may slide downward because of the placement or collision. This may cause the electronic devices hardly to be stably fixed on the support frame and result in inconvenience in use. Also, the foldable support frames may only be folded into one mode, and may not be suitable for the devices with various sizes or the placement with different angles.

In view of this, the inventors have devoted themselves to the above-mentioned related-art, researched intensively and cooperated with the application of science to try to solve the above-mentioned problems. Finally, the invention which is reasonable and effective to overcome the above drawbacks is provided.

### SUMMARY OF THE INVENTION

An object of the invention is to make a support base be capable of being folded into multiple modes and having anti-slip support effect.

To accomplish the above object, the invention provides a foldable support base which includes a baseplate and a folding layer. The baseplate has two first sides corresponding to each other, two second sides corresponding to each other and at least one anti-slip slot disposed thereon. The folding layer is connected to the baseplate and has a fist cutting line, two second cutting lines and a folding line set. The first cutting line is of a U-shape and disposed adjacent to each of the second sides and one of the first sides. The second cutting lines are located inside the first cutting line and extended parallelly to each other. The first cutting line has two terminals. Each of the second cutting lines has a start point and an end point. The folding line set includes a first folding line extending from one start point to another start point, a second folding line extending from one end point to another end point, a third folding line arranged between the first folding line and the second folding line and extending from one of the second cutting lines to another one of the second cutting lines, and two fourth folding lines extending respectively from one of the terminals to one of the second cutting lines. A three-dimensional support structure is configured and folded by dividing the folding layer to multiple blocks through the first cutting line, the second cutting lines and the folding line set.

The invention further has the following functions. The baseplate and the folding layer are provided with magnets to keep the three-dimensional support structure fixed. The heat generated during the operation of the mobile electronic device may be dissipated through the gaps formed between the device and the three-dimensional support structure. Various extension functions may further be achieved through the extension cover plates extended from the support base.

### BRIEF DESCRIPTION OF THE DRAWINGS

FIG. 1 is a perspective schematic view of the invention in an opened status;

FIG. 2 is a perspective schematic view of the invention in a first folded status;

FIG. 3 is a perspective schematic view of the invention in a second folded status;

FIG. 4 is a cross-sectional view of the invention in the first folded status;

FIG. 5 is a cross-sectional view of the invention in the second folded status;

FIG. 6 is an exploded view of another embodiment of the invention; and

FIG. 7 is a perspective schematic view of another embodiment of the invention in a fully folded status.

### DETAILED DESCRIPTION OF THE INVENTION

To further disclose the features and technical contents of the invention, please refer to the following description and the drawings. However, the drawings are used for reference and description only, not for limitation to the invention.

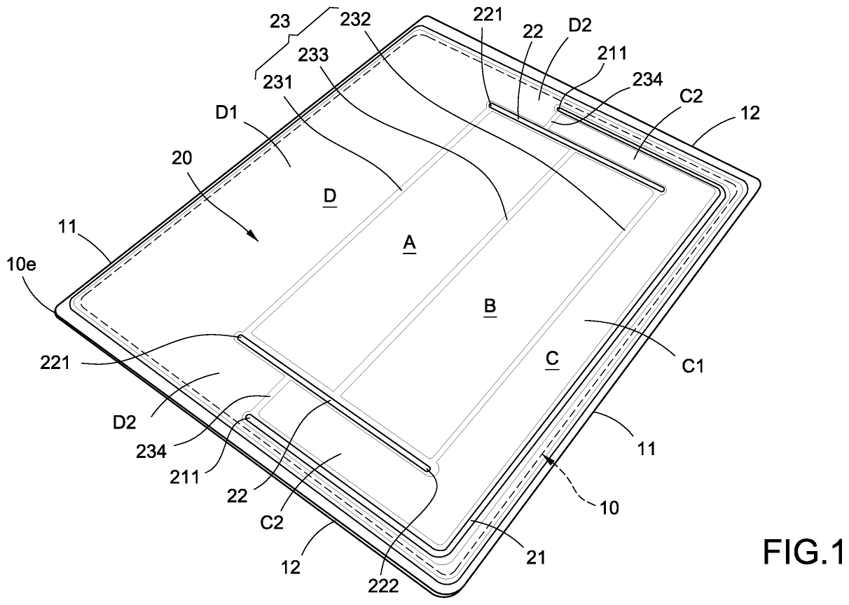

The invention provides a foldable support base for an object N to be placed aslant. The object N may be a book or a mobile electronic device such as a smartphone or a tablet. Please refer to FIGS. 1-3. The support base includes a baseplate 10 and a folding layer 20.

The baseplate 10 has an upper surface and a lower surface sealed with the upper surface. The upper surface may be made of a material with certain anti-slip effect. The lower surface is made of a soft element such as leather, rubber, or plastic. The baseplate 10 may have a shape of a parallelogram. Four corners of the baseplate 10 may be formed of chamfers 10e. The figures show a rectangular structure, but not limited to this, the baseplate 10 may also be a regular polygonal structure or a trapezoidal structure. This embodiment uses a rectangular structure as an example. The baseplate 10 has two first sides 11 corresponding to each other, two second sides 12 corresponding to each other and at least one anti-slip slot disposed thereon. The bottom of the object N may be placed in the anti-slip slot to prevent from sliding. In this embodiment, the anti-slip slot includes a first anti-slip slot 13 and a second anti-slip slot 14.

The folding layer 20 is configured by sealing two layers of soft elements such as leather, rubber, or plastic. The folding layer 20 is connected to the baseplate 10 and has a fist cutting line 21, two second cutting lines 22 and a folding line set 23. The first cutting line 21 is of a U-shape and disposed adjacent to each of the second sides 12 and adjacent to one of the first sides 11. The second cutting lines 22 are located inside the first cutting line 21 and extended parallelly with each other. The first cutting line 21 has two terminals 211. Each of the second cutting lines 22 has a start point 221 and an end point 222. The folding line set 23 includes a first folding line 231 extending from one start point 221 to the other start point 221, a second folding line 232 extending from one end point 222 to the other end point 222, a third folding line 233 arranged between the first folding line 231 and the second folding line 232 and extending from one of the second cutting lines 22 to the other one of the second cutting lines 22, and two fourth folding lines 234 extending respectively from each terminal 211 to each second cutting line 22. Further, the first anti-slip slot 13 is disposed on the baseplate 231 corresponding to the area between the first folding line 231 and the third folding line 233. The second anti-slip slot 14 is disposed on the baseplate 231 corresponding to the area between the second folding line 232 and the third folding line 233. A transversal width of each anti-slip slot is less than a transversal width of the third folding line 233 and a transversal width of the first cutting line 21.

A three-dimensional support structure 100 is folded and configured by dividing multiple blocks on the folding layer 20 through the first cutting line 21, the second cutting lines 22 and the folding line set 23. Each block includes a first block A, a second block B, a third block C and a fourth block D. The first block A is partitioned by the second folding line 232 and the third folding line 233 and separable from the baseplate 10. The second block B is partitioned by the second folding line 232 and the third folding line 233 and separable from the baseplate 10. The third block C is partitioned by the second folding line 232 and the fourth folding line 234 and separable from the baseplate 10. The fourth block D is partitioned by the first folding line 231 and the fourth folding line 234 and fixed on the baseplate 10. The fixing method between the fourth block D and the baseplate 10 may be, but not limited to, in a manner of adhesion, sewing or pressing. The third block C and the fourth block D include a main block portion C1, D1 and two sub-block portions C2, D2 extended from each main block portion C1, D1 respectively. In this embodiment, the magnets are sheathed in each of the blocks of the baseplate 10 and the folding layer 20 to keep the three-dimensional support structure 100 fixed, but not limited to this. For example, each block may keep the three-dimensional support structure 100 fixed by clips or hook-and-loop fasteners.

It is noted that the three-dimensional support structure 100 of the embodiment may include some descriptions about the conditions of geometrical sizes, but those are only used to present an embodiment instead of limitations of the invention and for a person having ordinary skill in the art to realize and implement the invention via the specification and the drawings. The axial distances between each terminal 211 of the first cutting line 21 and the adjacent first side 11 are the same. The first block A and the second block B are a rectangular block respectively. In some embodiments, the areas of the rectangular blocks are the same. In the sub-block portions C2 of the third block C, the axial distance from each fourth folding line 234 to the second folding line 232 is greater than the axial distance from the second folding line 232 to the third folding line 233. In the main block portion D1 of the fourth block D, the axial distance from the first folding line 231 to the adjacent first side 11 is greater than or equal to the axial distance from the first folding line 231 to the third folding line 233.

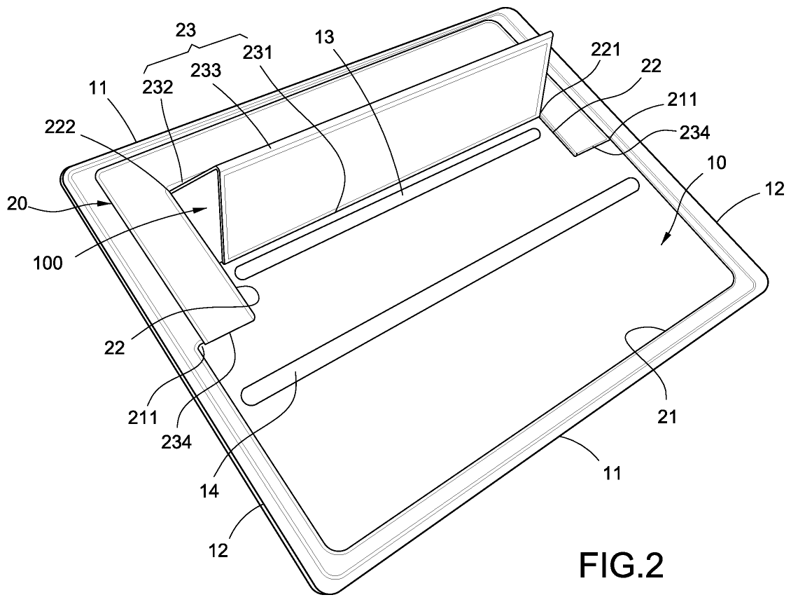

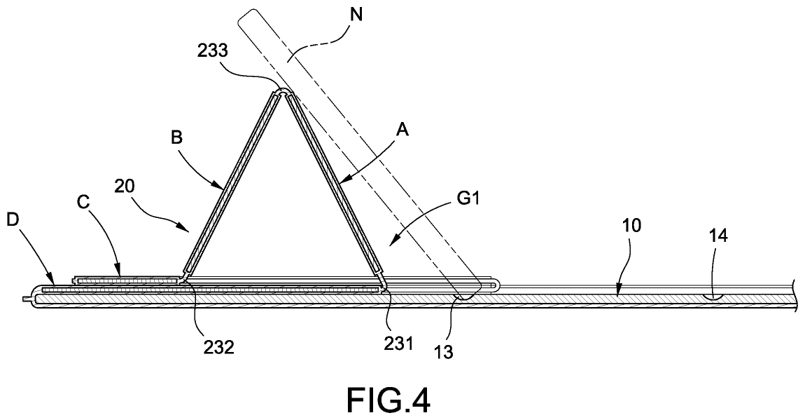

Please refer to FIGS. 2 and 4, which show the first folded mode of the embodiment for the user to place a small object N. The third block C is attached to the fourth block D by magnet attraction. The first block A and the second block B are folded through the third folding line 233 to form a triangular support structure with the fourth block D. In some embodiments, the support structure is in a shape of an isosceles triangle. As a result, the user may place the bottom of the object N in the first anti-clip slot 13 and make the object N abut against the top of the support structure. Thus, a gap G1 may be formed between the object N and the three-dimensional support structure 100. Also, the user may place the object N on the three-dimensional support structure vertically or horizontally. Furthermore, objects of various weight may be supported stably by the support structure in the shape of isosceles triangle to avoid deformation or collapse of the support structure because of overweight. The heat generated from the operation of the mobile electronic device may be dissipated by thermal convection through the gap G1.

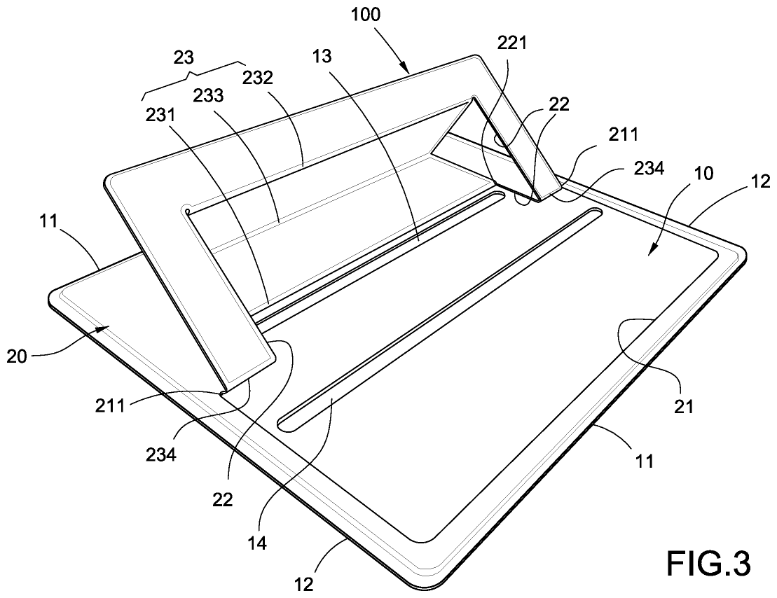

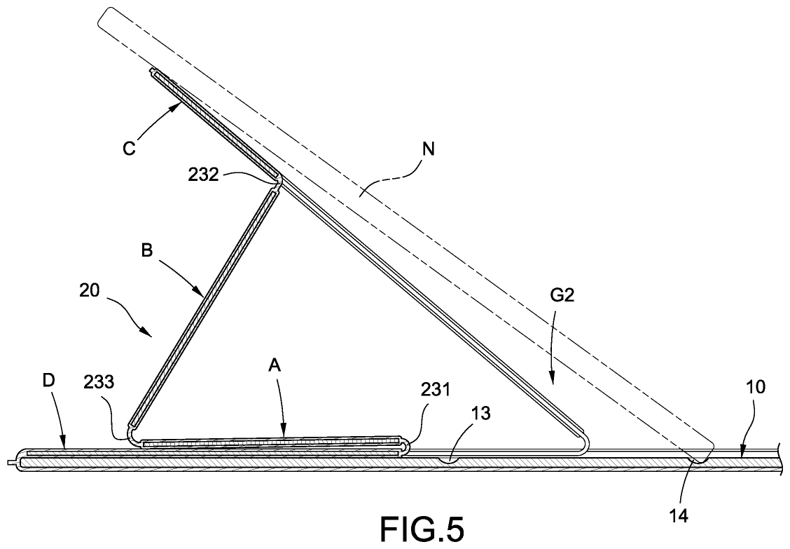

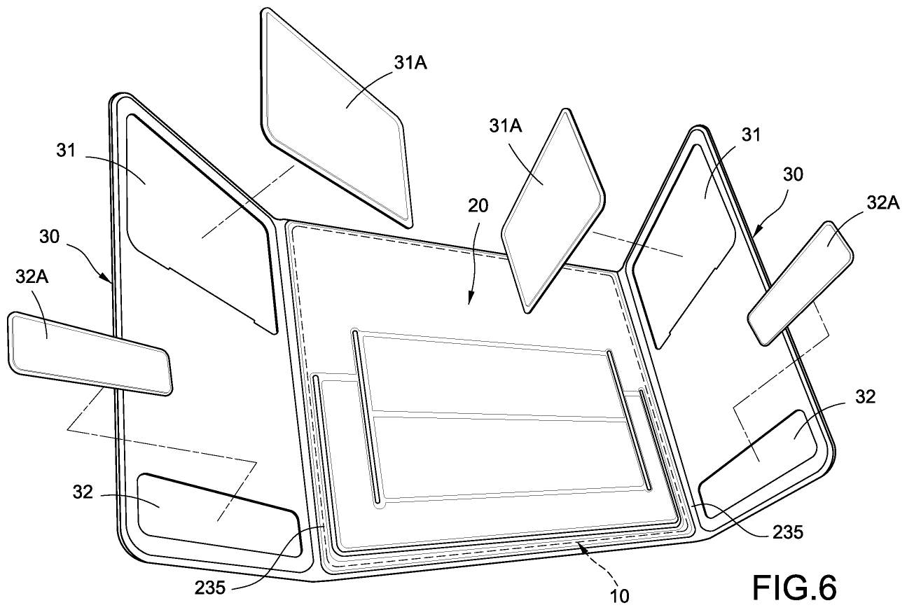

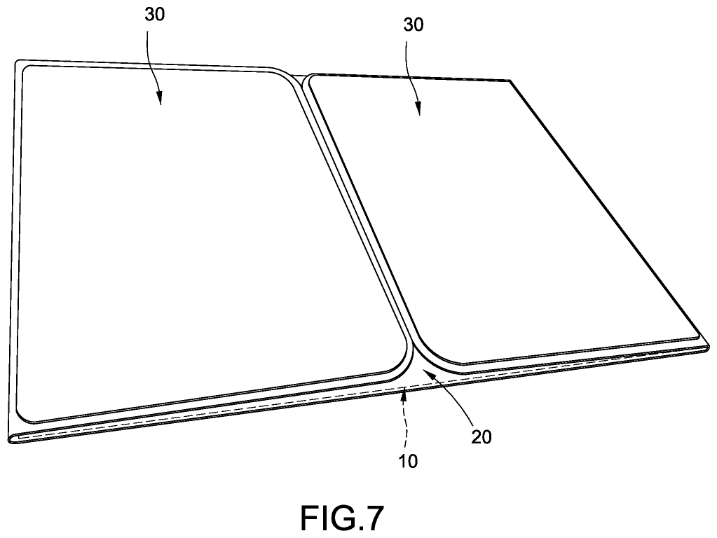

Please refer to FIGS. 3 and 5, which show the second folded mode of the embodiment for the user to place a large object N. The first block A is attached to the fourth block D by magnet attraction. The second block B and the third block C are folded through the second folding line 232 to form a triangular support structure with the fourth block D. As a result, the user may place the bottom of the object N in the second anti-clip slot 14 and make the object N abut against the main block portion Cl of the third block C. Thus, another gap G2 is formed between the object N and the three-dimensional support structure 100. Also, the user may place the object N on the three-dimensional support structure vertically or horizontally. Furthermore, the weight of different objects may be supported stably by the triangular support structure to avoid deformation or collapse of the support structure because of overweight. The heat generated from the operation of the mobile electronic device may be dissipated by thermal convection through the gap G2. In detail, please refer to FIGS. 6 and 7, which show another embodiment of the invention.

The difference is that an extension cover plate 30 is extended respectively from the second sides 12 on the right side and the left side of the baseplate 10. Each extension cover plate 30 may be configured by sealing two layers of soft elements such as leather, rubber, or plastic. A fifth folding line 235 is disposed between the baseplate 10 and each of the extension cover plates 30. As a result, the extension cover plates 30 on the right and left sides may be closed to store the support base. Also, the extension cover plates 30 may be provided with multiple magnets to make the extension cover plates 30 attach to and be fixed on the folding layer 20.

A first extension area 31 and a second extension area 32 are disposed on and cut out from each extension cover plate 30. Each extension area is provided with magnets covered therein. A cover 31A, 32A is attached to each first extension area and each second extension area for the user to cover the first extension area and the second extension area to keep up a tidy appearance when the first and second extension areas 31, 32 are not in use. In this embodiment, the first extension area 31 may be used to attract an attractable element (not shown in figures) such as a magnet. A paper strip or card may be clipped between the attractable element and the first extension area 31. The area between the first and second extension areas 31, 32 may serve as a mouse pad, so the user may not have to carry a mouse pad additionally. The second extension area 32 may be used to attract a pad (not shown in figures) for the user's arm to rest. When the user uses the mouse for long time, the pad may prevent the user's arm from suspending and the uncomfortable feeling may also be relieved. However, the invention is not limited to these, it is only for a person having ordinary skill in the art to realize and implement the invention via the specification and the drawings.

It will be appreciated by persons skilled in the art that the above embodiments have been described by way of example only and not in any limitative sense, and that various alterations and modifications are possible without departure from the scope of the invention as defined by the appended claims.

1. A foldable support base, comprising:
a baseplate, comprising an upper surface, a lower surface sealed with the upper surface, two first sides corresponding to each other, two second sides corresponding to each other, and at least one anti-slip slot disposed thereon, wherein the anti-slip slot comprises a first anti-slip slot and a second anti-slip slot, the first anti-slip slot and the second anti-slip slot are disposed on the upper surface, and the lower surface is free from opening; and
a folding layer, connected to the baseplate and comprising a fist cutting line, two second cutting lines and a folding line set, the first cutting line substantially in a U-shape and disposed adjacent to each of the second sides and one of the first sides, the second cutting lines located inside the first cutting line and extended parallelly with each other, the first cutting line comprising two terminals, each of the second cutting lines comprising a start point and an end point, the folding line set comprising:
a first folding line, extending from one start point to another start point;
a second folding line, extending from one end point to another end point;
a third folding line, arranged between the first folding line and the second folding line and extending from one of the second cutting lines to another one of the second cutting lines; and
two fourth folding lines, each extending from one of the terminals to one of the second cutting lines; wherein a three-dimensional support structure is configured and folded by dividing the folding layer to multiple blocks through the first cutting line, the second cutting lines and the folding line set.

2. The foldable support base of claim 1, the first anti-slip slot is disposed on the baseplate corresponding to an area between the first folding line and the third folding line, and the second anti-slip slot is disposed on the baseplate corresponding to an area between the second folding line and the third folding line.

3. The foldable support base of claim 1, wherein axial distances between each terminal of the first cutting line and an adjacent first side are the same.

4. The foldable support base of claim 3, wherein a first block is configured by the first folding line and the third folding line, a second block is configured by the second folding line and the third folding line, and the first block and the second block are separable from the baseplate.

5. The foldable support base of claim 3, wherein a third block is configured by the second folding line and the fourth folding line, the third block is separable from the baseplate and comprises a main block portion and two sub-block portions extended from the main block portion, and axial distance from the fourth folding line to the second folding line in the sub-block portions is greater than axial distance from the third folding line to the second folding line in the sub-block portions.

6. The foldable support base of claim 3, wherein a fourth block is configured by the first folding line and the fourth folding line, the fourth block is fixed on the baseplate and comprises a main block portion and two sub-block portions extended from the main block portion, and axial distance from the first folding line to the adjacent first side in the main block portion is greater than or equal to axial distance from the first folding line to the third folding line in the main block portion.

7. The foldable support base of claim 1, wherein an extension cover plate is extended from each of the second sides, and a fifth folding line is disposed between the baseplate and each of the extension cover plates.

8. The foldable support base of claim 7, wherein a first extension area and a second extension area are disposed on each extension cover plate.

9. The foldable support base of claim 7, wherein each extension cover plate comprises a soft element sealed with a magnet disposed therein.

10. The foldable support base of claim 1, wherein the baseplate and the folding layer comprises a soft element sealed with a magnet disposed therein.

11. The foldable support base of claim 1, wherein the baseplate comprises a shape of a parallelogram, each corner of the baseplate is a fillet edge, and a length of each first side is greater than a length of each second side.
